(19) United States
(12) Patent Application Publication
(10) Pub. No.: US 2011/0269343 A1
(43) Pub. Date: Nov. 3, 2011

(54) DISPLAY PORT CONNECTOR

(76) Inventor: Wan-Tien CHEN, Taipei (TW)

(21) Appl. No.: 12/769,923

(22) Filed: Apr. 29, 2010

(51) Int. Cl. H01R 24/00

(52) U.S. Cl. 439/626

(57) ABSTRACT

The present invention provides a display port connector, comprises: a housing; a base member; a first terminal set having plural first terminals, and each first terminal has a contact portion, a bended portion and a pin, wherein an arc-shaped bending part is formed between the bended portion and the contact portion and another arc-shaped bending part is formed between the bended portion and the pin; and a second terminal set having plural second terminals, each second terminal has a contact portion, a bended portion and a pin, the contact portion is received in the second terminal slot, the pin is exposed outside the housing, wherein an arc-shaped bending part is formed between the bended portion and the contact portion and another arc-shaped bending part is formed between the bended portion and the pin. After being assembled, the display port connector of the present invention is capable of receiving a display port plug, and the arc-shaped bending parts can be served to shorten the signal transmission distance for being advantageous for high frequency transmission.

### BACKGROUND OF THE INVENTION

1. Field of the Invention:

The present invention relates to a display port connector, especially to a display port connector capable of receiving a display port plug and the terminal thereof being installed with two arc-shaped bending parts for reducing signal transmission distance for being beneficial for high frequency transmission.

2. Description of Related Art:

With the development of technology, the resolution of a display device, e.g. a liquid display or liquid crystal television, has been increasing, and the liquid crystal television in the marketplace is often equipped with a high definition multimedia interface (HDMI) or a display port interface for connecting to a computer or other audio/video devices; wherein the HDMI can support up to resolution of 1600x1200, which utilizes a HDMI disport port connector having 19 pins. The display port interface is the next generation of HDMI which can support up to resolution of 2560x1600 and utilize a display port connector having 20 pins.

Referring to FIG. 1, which is a schematic side view of a terminal of conventional display port connector. As shown in FIG. 1, the terminal 100 of a conventional display port connector is installed with a contact portion 110, a bended portion 120 and a pin 130; three bending parts 121, 122 and 123 are formed between the contact portion 110 and the pin 130, wherein the bending angle of each bending part is different and the bending part 123 is almost bended to right angle (90 DEG), such that the signal transmission path of the terminal 100 is prolonged, and the right-angle bending part 123 is not advantageous for the transmission of high frequency signals.

So how to develop a novel display port connector capable of improving the mentioned shortages shall be conceded.

### SUMMARY OF THE INVENTION

One primary object of the present invention is to provide a display port connector capable of receiving a display port plug.

Another object of the present invention is to provide a display port connector in which a terminal being installed with two arc-shaped bending parts for reducing the signal transmission path so as to be advantageous for high frequency transmission.

One another object of the present invention is to provide a display port connector in which a plurality of partition slots being installed at the rear side of a base member for accommodating plural pins and for separating the pins and allowing the pins have same heights.

Still one another object of the present invention is to provide a display port connector in which a bump being installed on a contact portion for fastening the contact portion in a base member so as to prevent a terminal from up/down shaking

For achieving the objects mentioned above, the present invention provides a display port connector, comprises: a housing having an accommodating space; a base member received in the accommodating space, the front end thereof is extended with a tongue piece, a top surface of the tongue piece is installed with a plurality of first terminal slots, a bottom surface of the tongue piece is installed with a plurality of second terminal slots, and the first terminal slots and the second terminal slot are staggered with an up/down arrangement means; a first terminal set having plural first terminals, each first terminal has a contact portion, a bended portion and a pin, the contact portion is received in the first terminal slot, the pin is exposed outside the housing, wherein an arc-shaped bending part is formed between the bended portion and the contact portion and another arc-shaped bending part is formed between the bended portion and the pin; and a second terminal set having plural second terminals, each second terminal has a contact portion, a bended portion and a pin, the contact portion is received in the second terminal slot, the pin is exposed outside the housing, wherein an arc-shaped bending part is formed between the bended portion and the contact portion and another arc-shaped bending part is formed between the bended portion and the pin.

### BRIEF DESCRIPTION OF THE DRAWINGS

FIG. 1 is a schematic side view of a terminal of conventional display port connector;

FIG. 2a is a schematic front exploded view of the display port connector of one preferred embodiment of the present invention;

FIG. 2b is a schematic rear exploded view of the display port connector of one preferred embodiment of the present invention;

FIG. 3a is a schematic enlarged view of the first terminal of the present invention;

FIG. 3b is a schematic enlarged view of the second terminal of the present invention;

FIG. 4 is a schematic view of the assembly of the display port connector of the present invention.

### DETAILED DESCRIPTION OF THE PREFERRED EMBODIMENT

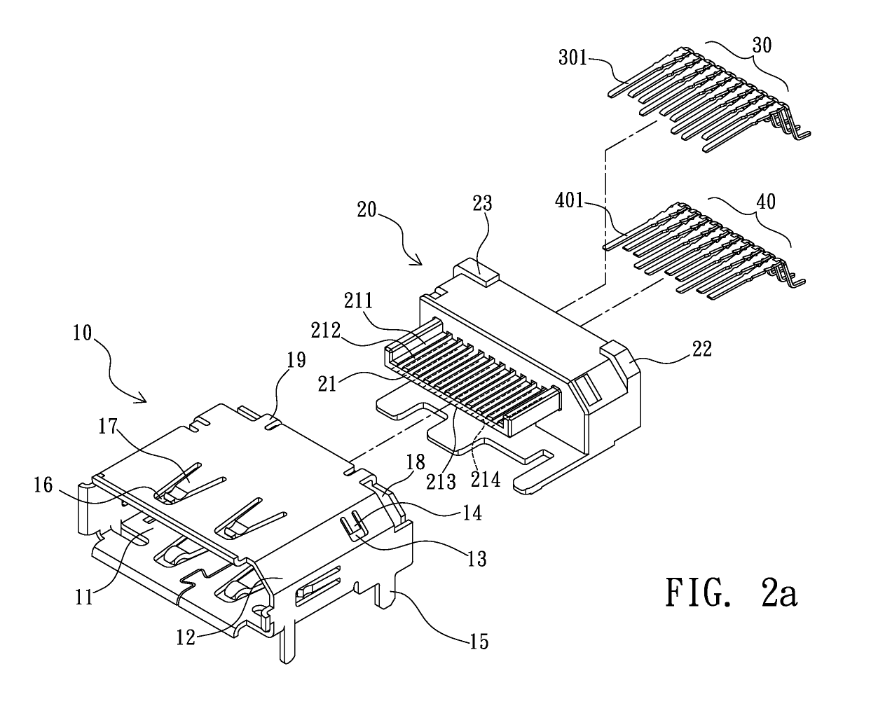

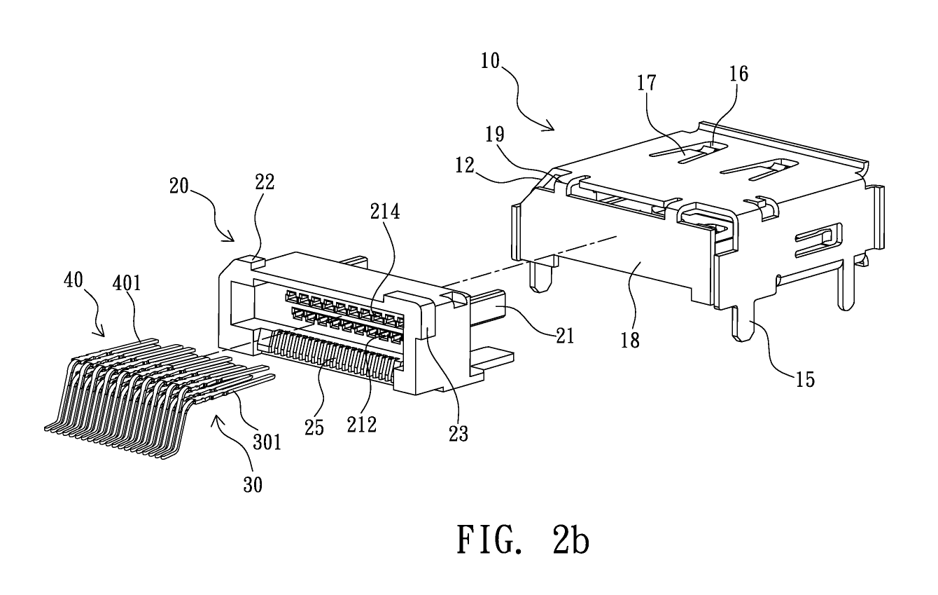

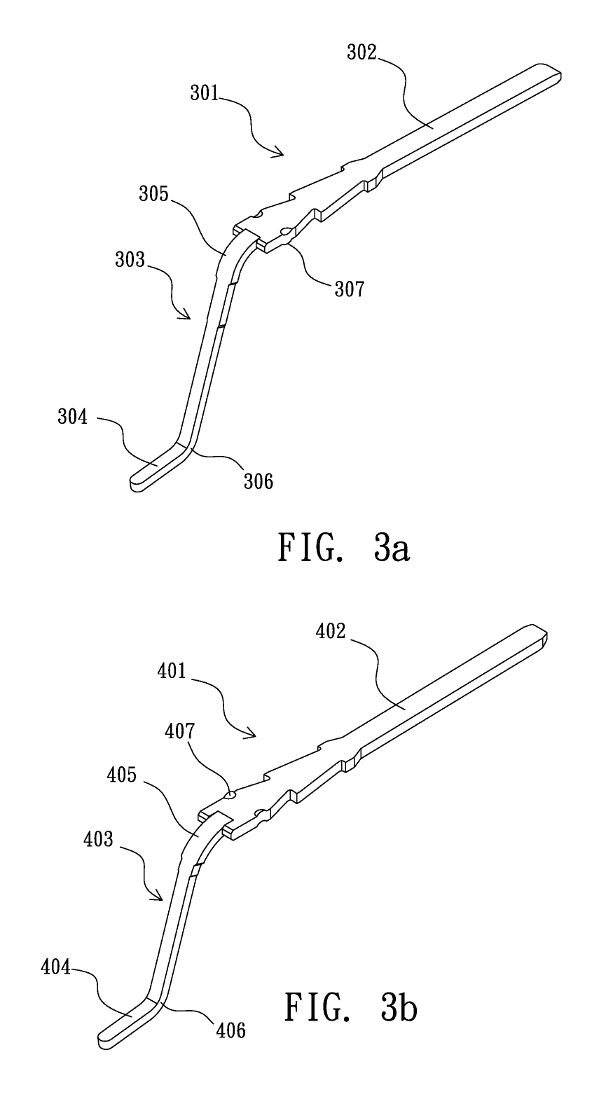

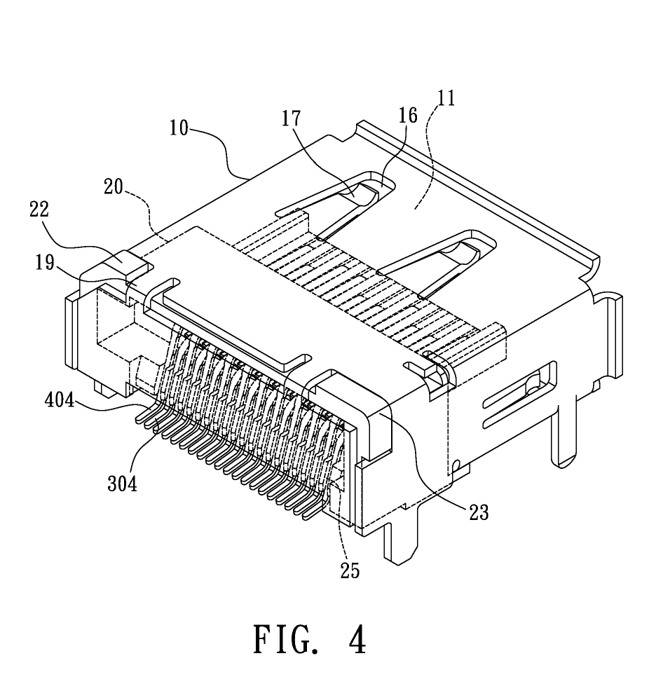

Referring from FIG. 2a to FIG. 4, wherein FIG. 2a is a schematic front exploded view of the display port connector of one preferred embodiment of the present invention; FIG. 2b is a schematic rear exploded view of the display port connector of one preferred embodiment of the present invention; FIG. 3a is a schematic enlarged view of the first terminal of the present invention; FIG. 3b is a schematic enlarged view of the second terminal of the present invention; FIG. 4 is a schematic view of the assembly of the display port connector of the present invention.

As shown in figures, the display port connector provided by the present invention comprises: a housing 10; a base member 20; a first terminal set 30; and a second terminal set 40.

The housing 10 is installed with an accommodating space 11. The housing 10 is made of, e.g. but not limited to, metal material, which is a conventional arts and is not the feature of the present invention, therefore no further illustration is provided. The right side of the housing 10 has an oblique surface 12 having a first opening 13, the first opening 13 is installed with a buckling portion 14. Moreover, bottom ends of two lateral walls of the housing 10 are further installed with at least one welding sheet 15 for being installed and fastened on a printed circuit board (not shown), for achieving the purpose of fastening.

The top wall and the bottom wall of the housing 10 are respectively installed with a second opening 16 having an inward-bended grounding resilient sheet 17. The rear end of the housing 10 has a shield sheet 18 connected to the housing 10 through two connecting arms 19, an long interval is defined between the shield sheet 18 and the bottom end of the housing 10 for assembling the base member 20.

The base member 20 is received in the accommodating space 11, and is preferably made of insulation material, and the front end thereof is extended with a tongue piece 21, a top surface 211 of the tongue piece 21 is formed with a plurality of first terminal slots 212, a bottom surface 213 of the tongue piece 21 is formed with a plurality of second terminal slots 214, and the first terminal slots 212 and the second terminal slots 214 are staggered with an up/down arrangement means. Wherein the first terminal slots 212 are, e.g. but not limited to, disposed on the top surface 211 of the tongue piece 21, the second terminal slots 214 are, e.g. but not limited to, disposed on the bottom surface 213 of the tongue piece 21. Moreover, two lateral sides of the rear end of the base member 20 are respectively provided with a latching block 22, 23.

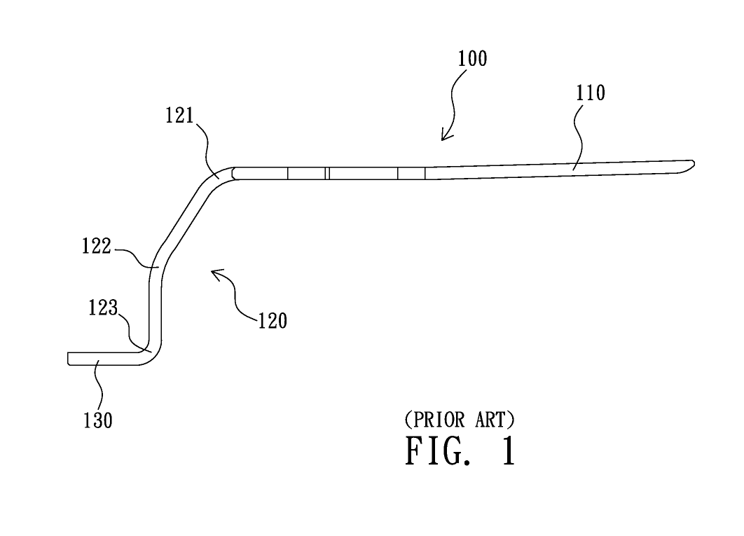

The first terminal set 30 has a plurality of first terminals 301, the quantity thereof is ten and disposed on the top surface 211 of the tongue piece 21, as shown in FIG. 3a, each first terminal 301 has a contact portion 302, a bended portion 303 and a pin 304, the plural contact portions 302 are respectively received in the first terminal slots 212, the plural pins 304 are exposed outside the housing 10; wherein an arc-shaped bending part 305 is formed between the bended portion 303 and the contact portion 302 and an arc-shaped bending part 306 is formed between the bended portion 303 and the pin 304. A distal end of each pin 304 is horizontally bended so as to be parallel to each other. As such, compared to the three bending parts of the conventional terminal 100 as shown in FIG. 1, the first terminal 301 of the present invention only has two bending parts 305, 306 for shortening the signal transmission path of the first terminal 301 and the arc-shaped bending parts 305, 306 are more beneficial for the transmission of high frequency signal compared to the right-angle bended bending part of conventional terminals.

The contact portion 302 is further provided with a bump 307 for fastening the contact portion 302 in the base member 20 so as to prevent the first terminal 301 from up/down shaking

The second terminal set 40 has a plurality of second terminals 401, the quantity thereof is ten and disposed on the bottom surface 213 of the tongue piece 21, as shown in FIG. 3b, each second terminal 401 has a contact portion 402, a bended portion 403 and a pin 404, the plural contact portions 402 are respectively received in the second terminal slots 214, the plural pins 404 are exposed outside the housing 10; wherein an arc-shaped bending part 405 is formed between the bended portion 403 and the contact portion 402 and an arc-shaped bending part 406 is formed between the bended portion 403 and the pin 404. A distal end of each pin 404 is horizontally bended so as to be parallel to each other. As such, compared to the three bending parts of the conventional terminal 100 as shown in FIG. 1, the second terminal 401 of the present invention only has two bending parts 405, 406 for shortening the signal transmission path of the second terminal 401 and the arc-shaped bending parts 405, 406 are more beneficial for the transmission of high frequency signals compared to the right-angle bended bending part of conventional terminals.

The contact portion 402 is further provided with a bump 407 for fastening the contact portion 402 in the base member 20 so as to prevent the second terminal 401 from up/down shaking

Moreover, a plurality of partition slots 25 are installed at the rear end of the base member 20 and below the second terminal slots 214, the quantity thereof is the sum of the quantity of first terminals 301 and the quantity of second terminals 401, e.g. the sum is twenty; the partition slots 25 are served to accommodate the plural pins 304, 404, but also served to separate the plural pins 304, 404 and to allow the plural pins 304, 404 have the same heights for facilitate welding operations.

As shown in FIG. 4, when assembling the base member 20, the first terminal set 30 and the second terminal set 40, the contact portion 302 of each of the first terminals 301 is respectively installed in the first terminal slot 212 from the rear end of the base member 20, and the pins 304 thereof are downwardly extended and fastened in the partition slots 25; then the contact portion 402 of each of the second terminals 401 is respectively installed in the second terminal slots 214 from the rear end of the base member 20, and the pins 404 thereof are downwardly extended and fastened in the partition slots 25, wherein the pins 304, 404 are aligned in parallel; the assembled base member 20 is installed in the accommodating space 11 from the long interval defined at the bottom end of the housing 10, so the latching blocks 22, 23 are respectively exposed and latched at lateral walls between the connecting arms 19 and the housing 10. The assembled display port connector of the present invention is able to be served to receive a display port plug (not shown).

As mentioned above, the display port connector provided by the present invention has following advantages: 1. the terminal has two arc-shaped bending parts for reducing the signal transmission distance and being adventurous for high frequency transmission; 2. the rear end of the base member is installed with plural partition slots for accommodating the pins and also for separating the pins and letting the pins have the same heights; and 3. the contact portion is further installed with a bump for fastening the contact portion in the base member so as to prevent the terminal from up/down shaking Thus the display port connector of the present invention is novel compared to conventional display port connectors.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display port connector, comprising:
a housing having an accommodating space;
a base member received in said accommodating space, the front end thereof being extended with a tongue piece, a top surface of said tongue piece being installed with a plurality of first terminal slots, a bottom surface of said tongue piece being installed with a plurality of second terminal slots, and said first terminal slots and said second terminal slot being staggered with an up/down arrangement means;
a first terminal set having plural first terminals, each of said first terminals having a contact portion, a bended portion and a pin, said contact portion being received in said first terminal slot, said pin being exposed outside said housing, wherein an arc-shaped bending part being formed between said bended portion and said contact portion and another arc-shaped bending part being formed between said bended portion and said pin; and
a second terminal set having plural second terminals, each of said second terminals having a contact portion, a bended portion and a pin, said contact portion being received in said second terminal slot, said pin being exposed outside said housing, wherein an arc-shaped bending part being formed between said bended portion and said contact portion and another arc-shaped bending part being formed between said bended portion and said pin.

2. The display port connector as claimed in claim 1, wherein said housing is made of metal materials, and the right side thereof has an oblique surface installed with a first opening having a buckling portion.

3. The display port connector as claimed in claim 1, wherein two sides of the rear end of said base member are respectively installed with a latching block.

4. The display port connector as claimed in claim 1, wherein bottom ends of two lateral walls of said housing are further extended with at least one welding sheet for being installed and fastened on a printed circuit board for achieving the purpose of fastening.

5. The display port connector as claimed in claim 1, wherein the quantity of said first terminal is ten and said first terminals are disposed on said top surface of said tongue piece;
the quantity of said second terminal is ten and said second terminals are disposed on said bottom surface of said tongue piece.

6. The display port connector as claimed in claim 5, wherein all said plural first terminals and said plural second terminals are electrically connected to terminals of a display port plug.

7. The display port connector as claimed in claim 5, wherein the top wall and the bottom wall of said housing are respectively installed with a second opening having an inward-bended grounding resilient sheet.

8. The display port connector as claimed in claim 1, wherein a plurality of partition slots are installed at the rear end of said base member and below said second terminal slots, the quantity thereof is the sum of the quantity of first terminals and the quantity of second terminals, for accommodating said plural pins, for separating said plural pins and for allowing said plural pins having the same heights.

9. The display port connector as claimed in claim 1, wherein each of said contact portions is further installed with a bump for fastening said contact portion in said base member.
